(19) United States
(12) Patent Application Publication
(10) Pub. No.: US 2005/0117962 A1
(43) Pub. Date: Jun. 2, 2005

(54) Culinary brush

(76) Inventors: Mathieu Lion, Paris (FR); Lucas Bignon, Cachan (FR)

Correspondence Address: Mark Montague;Cowan, Liebowitz & Latman, P.C., 1133 Avenue of the Americas, New York, NY, 10036, US

(21) Appl. No.: 10/822,083

(22) Filed: Apr. 8, 2004

(30) Foreign Application Priority Data
Nov. 27, 2003 (EP) EP 03292953.1

(51) Int. Cl. A23L 1/216; A47L 13/22; A46B 11/04; B43M 11/06

(52) U.S. Cl. 401/278; 401/270; 401/183

(57) ABSTRACT

A culinary brush having a handle containing an internal, flexible reservoir for containing a sauce or other suitable item to be dispensed, and a nozzle that is detachably coupled to the brush. The nozzle includes an internal channel through which the sauce may be dispensed and bristles disposed on the nozzle's end for evenly spreading the dispensed sauce on a food product.

### FIELD OF THE INVENTION

The present invention pertains to a culinary brush. More particularly, the present invention pertains to a culinary brush that dispenses and spreads sauces and other suitable items in culinary applications.

### BACKGROUND OF THE INVENTION

Brushes for culinary application (culinary brushes) are utilized in a variety of ways including, for example, spreading and/or applying sauces, fatty materials, egg yolks, etc., on foods or dishes principally to improve taste or aesthetic appeal.

Many different types of culinary brushes exist. Known examples include those disclosed in the following U.S. patents: D455,559; D456,615; D458,760 and D465,336. These known brushes and others are quite useful. However, such brushes often are not fully satisfactory. For example, such brushes often do not enable the user to uniformly apply sauces and other liquids or partial-liquid items on food.

In addition to culinary brushes, numerous sauce bags for use in the culinary arts exist. Various known bags include those disclosed in the following patents: DE-G-94 00 551; U.S. Pat. No. 3,029,464; U.S. Pat. No. 5,787,799; U.S. Pat. No. 5,934,187 and U.S. Pat. No. 6,575,651. The device disclosed in U.S. Pat. No. 6,244,308 consists of a bag equipped with a nozzle capable of being provided with a brush. However, sauce bags including the device in U.S. Pat. No. 6,244,308 have not been very successful principally due to difficulty in their use.

### OBJECTS AND SUMMARY OF THE INVENTION

Accordingly, it is an object of the present invention to perfect the state of the technique of applying and spreading sauces and the like. In particular, it is an object to provide a brush for use in the culinary arts that can spread sauces and other items to foods in a simple, easy, uniform and efficient manner.

These objects are achieved by providing a culinary brush in accordance with the present invention that includes a handle with a flexible reservoir that is in communication with the brush or bristle portion. Compared with known prior culinary brushes, the present invention advantageously allows controlled diffusion of a sauce or equivalent from the reservoir and thus makes it possible to improve uniformity of its application. The present invention also advantageously is easy to handle. The handle can be held and squeezed in a manner that easily controls the amount of sauce or other item to be applied to a food or dish.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a perspective view of a schematic illustration of the culinary brush in accordance with the present invention;

FIG. 2 is a side view of the handle including a reservoir of the culinary brush in accordance with the present invention,

FIG. 3 is a cross-sectional view showing the handle of the culinary brush in accordance with the present invention;

FIG. 4 is a side view of the brush nozzle portion of the culinary brush in accordance with the present invention;

FIG. 5 is a cross-sectional view of the brush nozzle portion of the culinary brush in accordance with the present invention;

FIG. 6 is a top plan view of the culinary brush in accordance with the present invention;

FIG. 7 is a top plan view of the culinary brush in accordance with another embodiment of the present invention;

FIG. 8 is a top plan view of the culinary brush in accordance with a further embodiment of the present invention; and

FIG. 9 is an illustration of the culinary brush in accordance with still yet a further embodiment of the present invention.

### DETAILED DESCRIPTION OF THE INVENTION

The culinary brush of the present invention, as shown in FIGS. 1-6 of the drawings, includes two principal components: a reservoir handle 100 (or simply “handle” 100) and a brush nozzle 200 (or “nozzle” 200). The brush nozzle 200 is detachably mounted on reservoir handle 100 and thus is used as a “plug” for the latter. Parts 100 and 200 are advantageously made from the same food-compatible material. In particular preferred embodiments, both parts are silicone, rubber, natural elastomer, or synthetic material.

In accordance with the present invention, handle 100 and nozzle 200 are made from the same material and thus advantageously avoids, or at least minimizes, risk of differential thermal expansion which in turn could result in leakage at positions at which the two parts interconnect, as further discussed below.

As shown in FIGS. 1-3 of the drawings, reservoir handle 100 has an elongated shape, and may have a length of between 5 and 20 cm, preferably between 9 and 16 cm. In a particularly preferred version, the length is between 12 and 15 cm. The handle preferably has a larger transverse dimension of between 3 and 6 cm. In a particularly preferred version, the larger transverse dimension is between 4 and 5 cm. The handle's internal reservoir has a volume of between 10 and 80 cubic cm, and preferable between 20 and 50 cubic cm. A reservoir handle 100 having the above dimensions may be held with one hand, generally between the thumb and the other fingers. Its handling proves to be incomparably easier than that of the reservoirs of known sauce bags.

As shown in FIG. 3, reservoir handle 100 has an opening 110 that is shaped to allow elastic deformation when it is subjected to compressive force, by returning spontaneously to its configuration in expansion after application of this force. An internal volume 120 (also called reservoir or chamber 120) of the handle presents a surface with a continuous curvature. Thus, the entire volume is directly accessible from opening 110. By providing the entire volume of reservoir 120 directly accessible, that is, without an undercut pocket or any inaccessible spaces, makes the reservoir completely accessible for washing. Hence, the internal volume can be completely sanitized during washing, thus providing good hygiene.

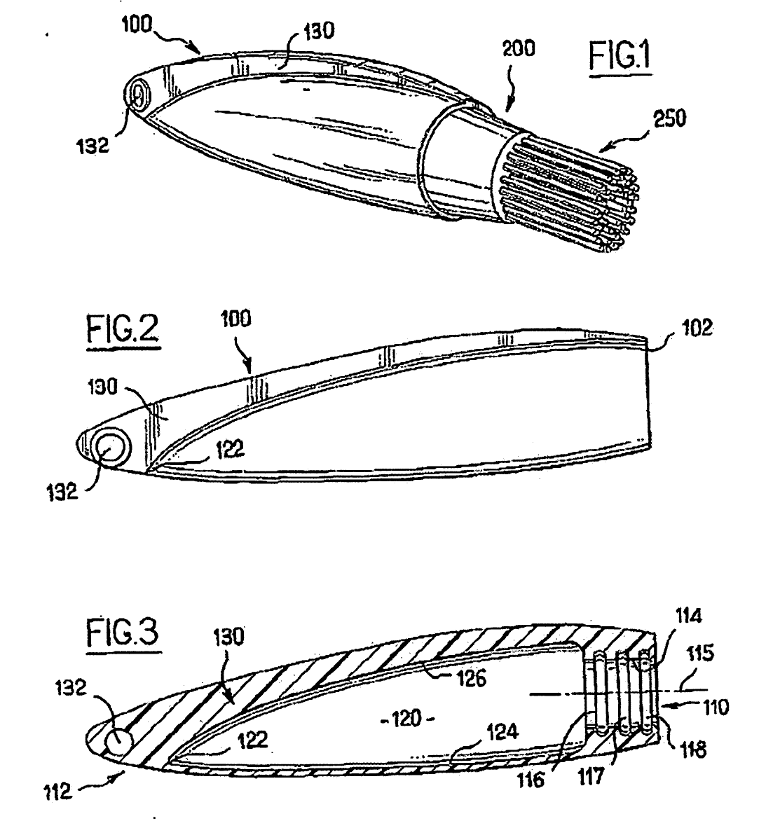

The reservoir handle 100 has the general shape of an elongated spindle truncated by plane (i.e., surface) 102 (shown in FIG. 2), transverse to its axis, at the level of opening 110. The internal volume 120 of reservoir handle 100 is defined overall by a surface with slight concavity directed towards the interior of chamber 120. Reservoir 120 extends from the circular-shaped (also called ring-shaped) opening 110 to its closed end 122 shown in FIG. 3. The cross-sectional area of reservoir 120 progressively expands from its closed-end 122 towards its open end at opening 110. Preferably, reservoir handle 100 along with reservoir 120 is symmetrical along its longitudinal section plane. The reservoir handle preferably is not symmetrical along its orthogonal longitudinal plane. Reservoir handle 100 is not completely symmetrical along its center longitudinal axis 115 (FIG. 3).

As shown in FIG. 3, lower surface 124 of reservoir 120 presents a deflection on the order of 2 to 4 mm, preferably 3 mm, along a length of approximately 95 mm, and upper surface 126 has a deflection of between 8 and 12 mm, preferably 10 mm, along a length of roughly 95 mm.

As best shown in FIG. 1, reservoir handle 100 preferably includes an external rib 130 that extends longitudinally across handle 100 along its top surface, along the the above-mentioned plane of symmetry, from opening 110 to the handle's back end 112 (FIG. 3). Back end 112 preferably includes an aperture (or orifice) 132 shaped as a clevis type eyelet. It is noted that the surfaces defining internal chamber 120 presents an upper concavity in the plane of symmetry that coincides with rib 130.

The handle's opening 110 includes an inner channel 114 with a cylindrical surface of revolution about axis 115 which coincides approximately with the longitudinal axis of handle 100. Channel 114 includes three circular grooves 116, 117 and 118, each centered on axis 115 and distributed equally along the channel as shown in FIG. 3. The channels preferably have the shape of a semi-toroid. Preferably, the cross section of each groove 116, 117, 118 is semicircular. Grooves 116, 117, 118 within channel 114 of the handle's opening 110 form the means for retaining nozzle 200, as further discussed below.

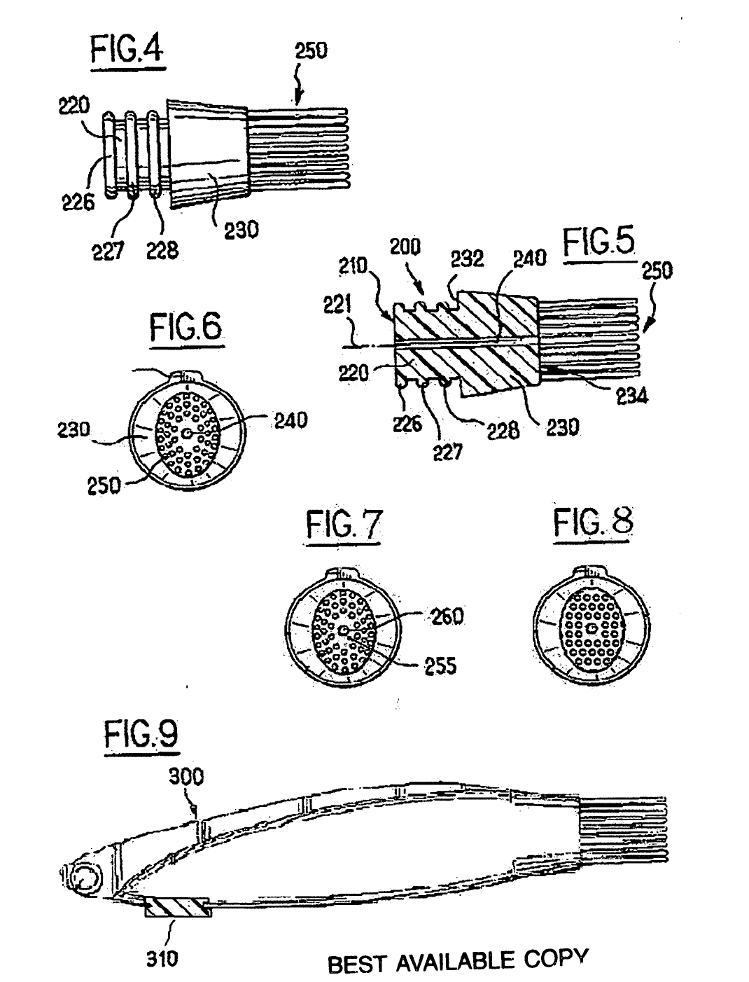

Referring now to brush nozzle 200 shown in FIGS. 4-6 of the drawings, nozzle 200 is designed to be coupled to handle 100 during use. Nozzle 200 includes a mass portion 210 having a cylindrical shaft 220 centered on a central axis 221. Shaft 220 includes exterior annular ridges 226, 227 and 228. Ridges 226, 227 and 228 are sized and positioned to be complementary to grooves 116, 117 and 118 so that, upon coupling nozzle 200 to handle 100, ridges 226, 227, 228 are respectively disposed within grooves 116, 117, 118. In such position, handle 100 and nozzle 200 are securely coupled to one another and, further, the shapes and sizes of the grooves and ridges are such so that the interconnection between the components is sufficiently tight to prevent any leakage of liquid within reservoir 120 via the grooves.

It is appreciated that while three grooves and three ridges are shown in the exemplary version of the culinary brush in accordance with the present invention, a different number of grooves and ridges may be provided. Moreover, the particular cross-sectional shape of ridges 226, 227, 228 and corresponding cross-sectional shape of grooves 116, 117, 118 may be different than that described above. By way of non-limiting example, shaft 220 may have a 17 mm diameter (complementing channel 114) and ridges 226, 227, 228 may have a 2.5 mm radius of curvature (complementing grooves 116, 117 and 118). Shaft 220 may have a 15 mm length, with ridges 226, 227, 228 being distributed equally along the shaft. Thus, the space between each adjacent pair of ridges corresponds to a cylindrical surface with a 2.5 mm width.

Mass portion 210 includes a truncated-type part 230 that extends from shaft 220, as shown in FIGS. 4 and 5. Truncated part 230 has a tapered external surface that includes a projection 232 (in the shape of a ring surface transverse to axis 221) at the portion that meets shaft 220. Upon coupling handle 100 and nozzle 200, projection 232 is designed to rest against the outer surface of the handle's opening 110. Projection 232 may have an external diameter of 20 mm.

Mass portion 210 includes a rectilinear central channel 240, disposed along axis 221, that extends through both shaft 220 and truncated part 230. Channel 240 preferably has a constant cross section and a diameter of 2 mm.

Nozzle 200 includes plural bristles 250 (also called hairs herein) that extend from truncated part 230, as shown in FIGS. 4 and 5. Central channel 240 is disposed in the center of nozzle 200 and ends at an opening within the area of the nozzle in which bristles 250 extend. Bristles 250 surround the opening. Preferably, three concentric rings of bristles 250 are provided which surround the opening of channel 240. By way of non-limiting example, a first ring of bristles 250 consists of 8 hairs, an intermediate ring consists of 14, and an outer-most ring consists of 20. Also, by way of non-limiting example, each bristle has a length of between 15 and 40 mm, preferably 25 mm with an average diameter of 1.5 mm. Further, truncated part 230 has a length of 15 mm.

Referring next to FIG. 6, which shows an exemplary top plan view of nozzle 200 of the present invention, it is seen that the bristles are not strictly concentric around axis 221, but rather the bristles are distributed preferably in a somewhat oval arrangement, with the long axis of such arrangement coinciding with the plane of symmetry shown in FIG. 3.

In accordance with the present invention, the culinary brush of the present invention includes two components: handle 100 and nozzle 200, which have been described as previously discussed. During use of the culinary brush of the present invention, handle 100 and nozzle 200 are coupled together, with the particular structural design of opening 110 of the brush (with grooves 116, 117, 118) and part 210 of the nozzle (with ridges 226, 227, 228) keeping the two components secured to one another without allowing leakage of liquid between the two components. Rather, liquid or liquid containing relatively small solids (food solids) is intended to be dispensed from reservoir 120 through channel 240 within nozzle 200, and out through the opening within the end of nozzle 200. Then, bristles 250 extending from the end of nozzle 200 can be utilized to evenly spread the dispensed substance on a food product or other item. The shape, size, number and dimension of the hairs (bristles) provide enhanced and superior spreading of the dispensed substance.

In accordance with the present invention, reservoir 120 within handle 100 may be filled with sauce or other appropriate item by pouring such item through opening 110 while handle 100 and nozzle 200 are disconnected. Further, and in accordance with the present invention, reservoir 120 may be filled by aspiration while handle 100 and nozzle 200 are connected, that is, by drawing liquid (or part liquid/part small solids) through the opening of channel 240 into reservoir 120. As is appreciated, this is accomplished by squeezing handle 100, placing the end of the brush (containing bristles 250) within a bowl or other object containing a sauce or other suitable liquid or semi-liquid product, and then releasing the handle to cause the liquid to be drawn through the opening of channel 240 and then into reservoir 120. It is appreciated that since bristles 250 are made of appropriate material, such as silicone, the end of the brush (containing the bristles) can be placed into a bowl containing a sauce (or other appropriate item) with the bristles bending to allow the opening of channel 240 to be placed sufficiently close to the bottom of the bowl thus allowing liquid to be drawn into the brush's reservoir even for the case when the bowl contains a relatively small amount of liquid.

As mentioned above, the culinary brush (including bristles 250) may be produced from silicone, rubber, natural elastomer or synthetic material suitable for use with food products. Such materials are particularly advantageous in terms of proper health and hygiene. In the arrangement described above, the brush of the present invention may be easily cleaned by any appropriate means, such as by hand washing or use of an automatic dishwasher.

Moreover, the use of the materials mentioned above advantageously provides a strong seal between the handle and nozzle components, when interconnected. The use of additional sealing components is not required. The particular material or materials of the components further enables efficient coupling and disconnection of the components due to the relative compressibility of the materials.

Having described a culinary brush in accordance with the present invention having particular features as discussed above and disclosed in the drawings, it will be appreciated that the present invention is not limited to the particular design described, and embodies brushes having variations not fully described herein. For example, the handle's opening 110 may include ridges with corresponding grooves being provided within the nozzle's shaft 220. As another example, bristles 250 may be made from a material different from nozzle 200, such as a thermo resistant material (e.g., Polyamide (e.g., nylon™), Kevlar™, Nomex™, etc.).

Moreover, another method of interconnection between the handle and the nozzle may be employed, such as a screw type connection or other known connection in which the components are secured in a way that prevents leakage while allowing the components to be easily disconnected from one another.

As yet another example, it is possible that nozzle 200 be made from a completely different type of material as mentioned above, such as a thermoplastic material or even metal. In such case, bristles 250 may be made from suitable materials different from nozzle 200 (elastomer, silicone, etc.). As yet a further example, handle 100 may include multiple parts, one part made from a material different from silicone and elastomer, for example, a thermoplastic material or metal.

As yet an additional example, the nozzle is provided with more than one channel. That is, multiple channels may be provided. Still yet, the nozzle may be equipped with one or more hollow bristles in which one or more channels within the nozzle are aligned with the channels within the hollow bristle(s). FIG. 7 shows a top plan view of the culinary brush containing a hollow bristle 255 extending from a channel 260. Thus, liquid within the reservoir is dispensed through channel 260 then through hollow bristle 255. Furthermore, bristles 250 (with or without one or more hollow bristles) may be arranged according to a geometry different from that previously described, for example in rows, such as shown in FIG. 8.

As still yet a further example, the nozzle and handle are integral to one another and thus are not detachable. In such case, the handle includes a closable opening. In one example of this particular variation, an opening is placed near eyelet 132, which may be closed using a detachable plug. An exemplary culinary brush with such a design is shown in FIG. 9 of the drawings. As shown, culinary brush 300 is a single integral components and a plug 310 allows access to the interior reservoir. In a perhaps preferred version of this variation, the plug closes an opening disposed at end 122 (shown in FIG. 2) so that, when the plug is removed, the entire reservoir is accessible for cleaning. In such case, the opening into the reservoir is at the opposite end as that provided for in the first embodiment discussed with respect to FIGS. 1-6 of the drawings. Therefore, it is provided that the plug may be disposed at any appropriate position to enable access to the brush's reservoir.

Therefore, it is intended that the appended claims be interpreted as including the embodiments described herein, the alternatives mentioned above, and all equivalents thereto.

1. A culinary brush, comprising:
a handle having a flexible reservoir; and
bristles in communication with the reservoir.

2. The brush according to claim 1, wherein both the handle and bristles are made of a material included in the group consisting of silicone or elastomer.

3. The brush according to claim 1, wherein both the handle and bristles are made of the same material.

4. The brush according to claim 1, wherein the handle containing the reservoir is adapted to be held and applied by one hand.

5. The brush according to claim 1, wherein the handle has a length between 5 and 20 cm.

6. The brush according to claim 1, wherein the handle has a greater transverse dimension between 3 and 6 cm.

7. The brush according to claim 1, wherein the reservoir has an internal volume between 10 and 80 cubic cm.

8. The brush according to claim 1, further comprising a nozzle coupled to the handle, the nozzle being adapted to be manually disconnected from the handle and including the bristles.

9. The brush according to claim 8, wherein the nozzle and handle are adapted to be detachably engaged to one another by use of complementary shaped features.

10. The brush according to claim 8, wherein the nozzle includes a cross channel through which an item within the reservoir can be dispensed.

11. The brush according to claim 10, wherein the bristles extend from an end of the nozzle opposite an end interconnected to the handle, the bristles distributed around an outlet of the cross channel.

12. The brush according to claim 11, wherein the bristles are substantially evenly distributed around the cross channel to form at least one ring of bristles around the cross channel.

13. The brush according to claim 12, wherein three concentric rings of bristles are distributed around the cross channel.

14. The brush according to claim 11, wherein each of the bristles has a length of between 15 and 40 mm.

15. The brush according to claim 8, wherein one of the handle and the nozzle includes at least one annular groove and the other of the handle and the nozzle includes a ridge adapted to be detachably coupled to the groove.

16. The brush according to claim 15, wherein said one of the handle and the nozzle including the at least one annular groove includes a tubular portion in which the groove is disposed.

17. The brush according to claim 8, wherein one of the handle and the nozzle includes three annular grooves centered on a common axis and the other of the handle and the nozzle includes three ridges, each of the ridges adapted to be detachably coupled to a respective one of the three grooves.

18. The brush according to claim 8, wherein the handle, the nozzle and the bristles are made from different materials.

19. The brush according to claim 1, wherein the handle is adapted to elastically deform such that the reservoir within the handle returns to a non-compressed shaped upon release of a compressive force on the handle.

20. The brush according to claim 1, wherein the handle includes an inner surface defining the reservoir that contains a continuous curvature such that the entire reservoir is directly accessible from an opening to the reservoir.

21. The brush according to claim 1, wherein the handle includes an internal reservoir extending from a closed end point to a circular shaped open end.

22. The brush according to claim 21, wherein the internal reservoir has an internal concave surface extending from the closed end point to the circular shaped open end and a cross-sectional area of the reservoir increases from the closed end point to the circular shaped open end.

23. The brush according to claim 1, wherein the handle has a shape of an elongated spindle.

24. The brush according to claim 1, wherein the handle includes an externally disposed rib, and the rib includes an orifice.

25. The brush according to claim 1, wherein the bristles are made from a thermoplastic material.

26. The brush according to claim 1, further comprising a nozzle coupled to the handle, the nozzle being adapted to be manually disconnected from the handle and including the bristles; and the nozzle is made from a thermoplastic material.

27. The brush according to claim 1, further comprising a nozzle coupled to the handle, the nozzle being adapted to be manually disconnected from the handle and including the bristles; and the nozzle is made from metal.

28. The brush according to claim 1, wherein the handle includes an opening for the reservoir, and the brush further comprising a plug detachably connected to the handle to block the opening.

29. The brush according to claim 1, further comprising at least one hollow bristle in communication with the reservoir.

30. The brush according to claim 1, wherein the bristles are arranged in rows.

31. The brush according to claim 1, wherein the handle is made partially from silicone or elastomer.

32. A culinary brush, comprising:
a handle having a flexible reservoir; and
a nozzle coupled to the handle, the nozzle being adapted to be manually disconnected from the handle.

33. The brush according to claim 32, wherein both the handle and nozzle are made of a material included in the group consisting of silicone or elastomer.

34. The brush according to claim 32, wherein the handle and nozzle are made from the same material.

35. The brush according to claim 32, wherein the handle is adapted to elastically deform such that the reservoir within the handle returns to a non-compressed shaped upon release of a compressive force on the handle.

36. The brush according to claim 32, wherein the handle includes an internal reservoir extending from a closed end point to a circular shaped open end.

37. The brush according to claim 32, wherein the nozzle includes at least one hollow bristle in communication with the reservoir when the nozzle and handle are coupled.
